(19) United States
(12) Patent Application Publication
(10) Pub. No.: US 2026/0134009 A1
(43) Pub. Date: May 14, 2026

(54) INFORMATION PROCESSING DEVICE, INFORMATION PROCESSING METHOD, AND NON-TRANSITORY COMPUTER-READABLE MEDIUM

(71) Applicant: Mitsubishi Electric Corporation, Tokyo (JP)

(72) Inventors: Shota TANAKA, Tokyo (JP); Kotaro SANAI, Tokyo (JP)

(73) Assignee: Mitsubishi Electric Corporation, Tokyo (JP)

(21) Appl. No.: 19/346,056

(22) Filed: Sep. 30, 2025

(30) Foreign Application Priority Data
Nov. 14, 2024 (JP) 2024-198912

(51) Int. Cl. G06F 16/3329; G05B 23/02

(52) U.S. Cl. CPC G06F 16/33295; G05B 23/0264

(57) ABSTRACT

What is provided is an information processing device capable of estimating a cause of a phenomenon on the basis of an event described in a sentence. The information processing device includes a question input unit into which a question inquiring about a cause of a phenomenon is input, an artificial intelligence I/F unit that inputs a group of sentences indicating causal relationships between events and the question input to the question input unit into a large-scale language model, and acquires a response to the question from the large-scale language model, and an output unit that outputs the response acquired by the artificial intelligence I/F unit.

### BACKGROUND OF THE INVENTION

### Field of the Invention

The present disclosure relates to an information processing device, an information processing method, and a non-transitory computer-readable medium.

This application claims priority to JP 2024-198912 filed on Nov. 14, 2024, the contents of which are incorporated herein by reference.

### Description of Related Art

Techniques of estimating the cause of an occurring phenomenon are known.

Patent Document 1 discloses, for causal relationships between phenomena in a process, a technique of estimating the causes of the phenomena by using a knowledge model expressed in the form of a network connecting nodes, with events occurring in the process as nodes, and data collected from the process.

### PATENT DOCUMENT

[Patent Document 1] International Patent Publication WO 2023/176467

### SUMMARY OF THE INVENTION

However, the technique disclosed in Patent Document 1 has a problem in that it may not be possible to estimate the cause of a phenomenon unless the events are set as nodes.

The present disclosure was contrived in view of such circumstances, and provides an information processing device, an information processing method, and a non-transitory computer-readable medium that make it possible to estimate the cause of a phenomenon on the basis of an event described in a sentence.

This disclosure was contrived in order to solve the above-described problem. According to an aspect of the present disclosure, there is provided an information processing device including: at least one processor; and a memory including instructions, which when executed on the at least one processor, cause the at least one processor to function as: a question input unit into which a question inquiring about a cause of a phenomenon is input; an artificial intelligence I/F unit that inputs a group of sentences indicating causal relationships between events and the question input to the question input unit into a large-scale language model, and acquires a response to the question from the large-scale language model; and an output unit that outputs the response acquired by the artificial intelligence I/F unit.

According to an aspect of the present disclosure, there is provided an information processing method including: inputting a question inquiring about a cause of a phenomenon; inputting a group of sentences indicating causal relationships between events and the question into a large-scale language model; acquiring a response to the question from the large-scale language model; and outputting the response acquired.

According to an aspect of the present disclosure, there is provided a non-transitory computer-readable medium having stored thereon a program for causing a computer to function as: a question input unit into which a question inquiring about a cause of a phenomenon is input; an artificial intelligence I/F unit that inputs a group of sentences indicating causal relationships between events and the question input to the question input unit into a large-scale language model, and acquires a response to the question from the large-scale language model; and an output unit that outputs the response acquired by the artificial intelligence I/F unit.

According to this disclosure, the information processing device, the information processing method, and the non-transitory computer-readable medium make it possible to estimate the cause of a phenomenon on the basis of an event described in a sentence.

### BRIEF DESCRIPTION OF THE DRAWINGS

FIG. 1 is a schematic block diagram illustrating the configuration of a cause response system 100 according to a first embodiment of this disclosure.

FIG. 2 is a table illustrating a first example of content stored in a causal relationship storage unit 12 in the same embodiment.

FIG. 3 is a table illustrating a second example of content stored in the causal relationship storage unit 12 in the same embodiment.

FIG. 4 is a flowchart illustrating a first example of an operation of an information processing device 10 in the same embodiment.

FIG. 5 is a flowchart illustrating a second example of an operation of the information processing device 10 in the same embodiment.

FIG. 6 is a schematic block diagram illustrating the configuration of a cause response system 100 in a second embodiment of this disclosure.

FIG. 7 is a tree diagram illustrating an example of data indicating causal relationships between events in the same embodiment.

FIG. 8 is a schematic block diagram illustrating the configuration of a cause response system 100 in a third embodiment of this disclosure.

FIG. 9 is a table illustrating an example of content stored in the causal relationship storage unit 12 in the same embodiment.

FIG. 10 is a first example of an image displayed by an output unit 14 in the same embodiment.

FIG. 11 is a second example of an image displayed by the output unit 14 in the same embodiment.

FIG. 12 is a third example of an image displayed by the output unit 14 in the same embodiment.

FIG. 13 is a diagram illustrating a hardware configuration of each device according to each embodiment.

### DETAILED DESCRIPTION OF THE INVENTION

### First Embodiment

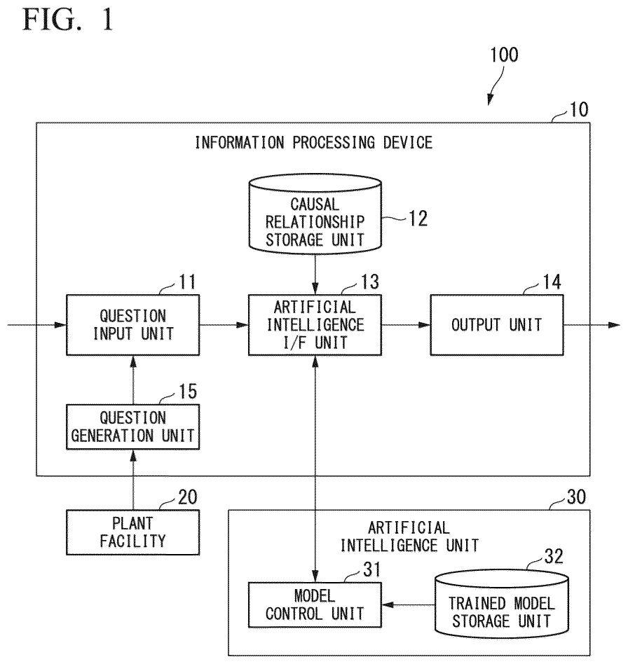

Hereinafter, embodiments of the present disclosure will be described with reference to the accompanying drawings. FIG. 1 is a schematic block diagram illustrating the configuration of a cause response system 100 according to a first embodiment of this disclosure. When a question inquiring about the cause of a phenomenon is input, the cause response system 100 uses an artificial intelligence unit 30 having an artificial intelligence (AI) function to output the response. In the present embodiment, the cause response system 100 will be described by taking as an example a case where the input question is a question inquiring about the cause of a phenomenon in a coal-fired power plant, but the question may be a question inquiring about the cause of a phenomenon in other subjects, such as facilities including factories and information processing systems, industrial products, or living organisms.

The cause response system 100 includes an information processing device 10 and the artificial intelligence unit 30. When a question inquiring about the cause of a phenomenon is input, the information processing device 10 inputs the question together with a group of sentences indicating the causal relationships between events to the artificial intelligence unit 30. The information processing device 10 acquires a response to the question from the artificial intelligence unit 30 and outputs the response. The question is, for example, “What is the cause of a rise in mill differential pressure despite the air damper being open?” and the response to the question is, for example, “The following causes can be assumed for a rise in mill differential pressure despite the air damper being open. 1. A rise in mill differential pressure due to accumulation of coal inside: This may be result from a decrease in the mill's crushing capacity due to wear on the crushing part, an increase in coal moisture content, or a decrease in pressurized oil pressure. 2. A decrease in primary air flow rate due to accumulation of coal inside: The accumulation of coal may obstruct the flow of primary air, resulting in a decrease in primary air flow rate. . . . Other events such as ○○ may also be observed.” In addition, the information processing device 10 may generate a question inquiring about the cause of a phenomenon on the basis of data acquired from a plant facility 20. The information processing device 10 may be realized by one or a plurality of computers reading and executing a program.

The information processing device 10 includes a question input unit 11, a causal relationship storage unit 12, an artificial intelligence Interface (I/F) unit 13, an output unit 14, and a question generation unit 15. The question input unit 11 has a question inquiring about the cause of a phenomenon input thereto. The question may be input using an input device such as a keyboard, a mouse, or a touch panel, or may be input by receiving it from another device. The phenomenon in the question is a phenomenon detected by monitoring the facility (the facility of the coal-fired power plant).

The causal relationship storage unit 12 stores a group of sentences indicating causal relationships between events. In addition, the causal relationship storage unit 12 may store a sentence indicating the type of event for each event in the group of sentences indicating the causal relationships between events. Meanwhile, the event is an event related to a facility. The type of event may include a cause, an internally occurring event, and an instrument-detected event. The cause is an event that serves as the cause of a phenomenon. The internally occurring event is an event that occurs in the facility but is an event which is not detected by any instrument. The instrumented event is an event which is detected by an instrument for monitoring the state of the facility.

The artificial intelligence I/F unit 13 inputs a group of input sentences, including at least a group of sentences indicating the causal relationships between events and a question input to the question input unit 11, to the artificial intelligence unit 30, and acquires a response to the question from the artificial intelligence unit 30. This response is a response regarding the cause of a phenomenon inquired about in the question. In addition, this response may further include a verifiable event. The verifiable event is an event different from the phenomenon of which the cause is inquired about in the question, and the type thereof is an instrument-detected event. In addition, the artificial intelligence I/F unit 13 may input sentences inquiring about verifiable events other than the phenomenon inquired about in the question to the artificial intelligence unit 30, in addition to the above-described group of sentences and questions. The verifiable event is an instrument-detected event, and a sentence indicating the type of event stored in the causal relationship storage unit 12 may be input to the artificial intelligence unit 30 in addition to the sentence inquiring about the above-described verifiable event, the above-described group of sentences, and the above-described question.

The output unit 14 outputs the response acquired by the artificial intelligence I/F unit 13. The response may be output by displaying the response on a display, or by transmitting it to another device. The question generation unit 15 generates a question to be input to the question input unit 11 on the basis of the detection results of the instruments installed in the plant facility 20. For example, the question generation unit 15 may store a question corresponding to each of a plurality of conditions, and select from the stored questions a question corresponding to the condition satisfied by the detection results of the instruments installed in the plant facility 20.

The plant facility 20 is a facility of a coal-fired power plant, and includes instruments for monitoring the state of the facility. The plant facility 20 provides the results of detection by the instruments, such as measured values of the instruments, to the information processing device 10 through a communication network or the like.

The artificial intelligence unit 30 (large-scale language model) refers to artificial intelligence having intelligent functions such as inference and judgment, and its operating environment. The artificial intelligence unit 30 includes a model control unit 31 and a trained model storage unit 32. The artificial intelligence unit 30 is a model and its operating environment configured to output a response corresponding to a question when a group of sentences indicating the causal relationships between events and the question input to the question input unit 11 are input. When a group of sentences indicating the causal relationships between events and a question input to the question input unit 11 are input from the artificial intelligence I/F unit 13, the artificial intelligence unit 30 outputs a response on the basis of the group of sentences, the question, and a trained model to be described later.

The trained model storage unit 32 stores a trained model. The trained model includes information on a model to be described later. The trained model may include model parameters, which are information that specifies the behavior of the model, such as, for example, constraint conditions, weighting variables, and evaluation functions.

The model may be, for example, a model referred to as a neural network (NN), convolutional neural network (CNN), recurrent neural network (RNN), variational autoencoder (VAE), generative adversarial networks (GAN), diffusion model, transformer, large language model (LLM), visual language model (VLM), bidirectional encoder representations from transformers (BERT), generative pre-trained transformer (GPT), or contrastive language image pre-training (CLIP). Meanwhile, the above-described models are not exclusive, and, for example, LLM, VLM, BERT, and GPT are included in the transformer. In addition, for example, the transformer is included in the NN. In addition, the learning algorithm and model may be a combination of a plurality of types. The model also includes a so-called multimodal model trained by combining a plurality of different types of data.

When a group of sentences indicating the causal relationships between events and a question input to the question input unit 11 are acquired, the model control unit 31 outputs a response corresponding to the question on the basis of the group of sentences, the question, and the trained model. That is, when a group of sentences indicating the causal relationships between events and a question input to the question input unit 11 are acquired, the model control unit 31 generates and outputs a response corresponding to the question using the model indicated by the trained model.

Meanwhile, the trained model and other information used by the artificial intelligence unit 30 may be prepared in advance, or may be acquired through a network as necessary.

Meanwhile, FIG. 1 illustrates a case where the artificial intelligence unit 30 is provided outside the information processing device 10. However, there is no limitation thereto, and a part or all of the artificial intelligence unit 30 may be provided inside the information processing device 10. In a case where a part or all of the artificial intelligence unit 30 is provided inside the information processing device 10, the information processing device 10 may configured so that the artificial intelligence I/F unit 13 has the function of the model control unit 31.

In addition, the trained model storage unit 32 may be constituted by a plurality of databases connected to each other through a network.

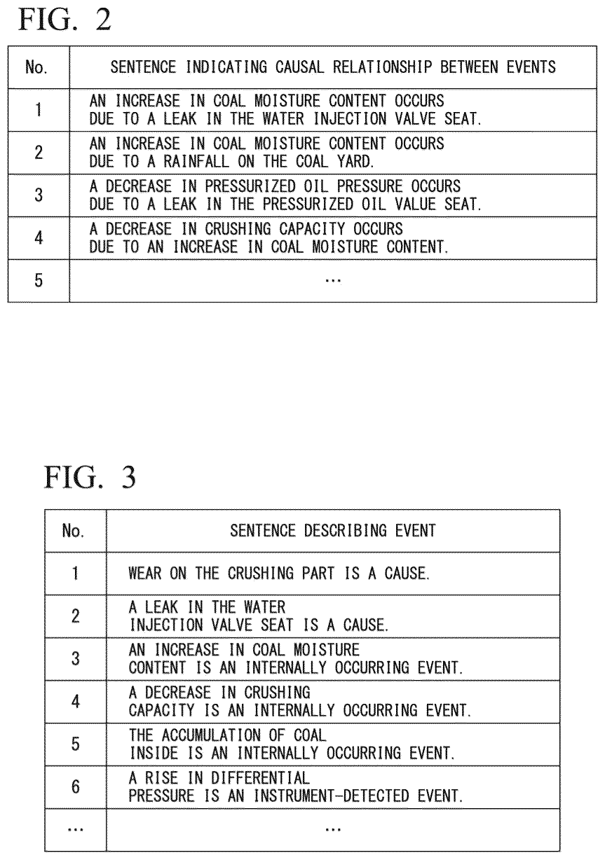

FIG. 2 is a table illustrating a first example of content stored in the causal relationship storage unit 12 in the present embodiment. The example in FIG. 2 is a group of sentences indicating the causal relationships between events stored in the causal relationship storage unit 12. The sentences indicating the causal relationships between events shown in the drawing include “An increase in coal moisture content occurs due to a leak in the water injection valve seat,” “An increase in coal moisture content occurs due to a rainfall on the coal yard,” “A decrease in pressurized oil pressure occurs due to a leak in the pressurized oil value seat,” and “A decrease in crushing capacity occurs due to an increase in coal moisture content,” and the like.

FIG. 3 is a table illustrating a second example of content stored in the causal relationship storage unit 12 in the present embodiment. The example in FIG. 3 is a group of sentences indicating the type of event stored in the causal relationship storage unit 12. The sentences indicating the types of event shown in FIG. 3 include “Wear on the crushing part is a cause,” “A leak in the water injection valve seat is a cause,” “An increase in coal moisture content is an internally occurring event,” “A decrease in crushing capacity is an internally occurring event,” “The accumulation of coal inside is an internally occurring event,” and “A rise in differential pressure is an instrument-detected event.”

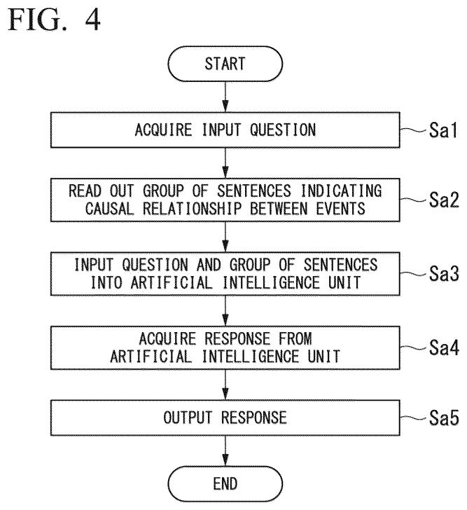

FIG. 4 is a flowchart illustrating a first example of an operation of the information processing device 10 in the present embodiment. FIG. 4 is a flowchart in a case where a question inquiring about the cause of a phenomenon is input from outside. First, the question input unit 11 acquires the input question (step Sa1). Next, the artificial intelligence I/F unit 13 reads out a group of sentences indicating the causal relationships between events from the causal relationship storage unit 12 (step Sa2), and inputs the question acquired in step Sa1 and the group of sentences read out in step Sa2 to the artificial intelligence unit 30 (step Sa3). Next, the artificial intelligence I/F unit 13 acquires a response to the input in step Sa3 from the artificial intelligence unit 30 (step Sa4). Next, the output unit 14 outputs the response acquired in step Sa4.

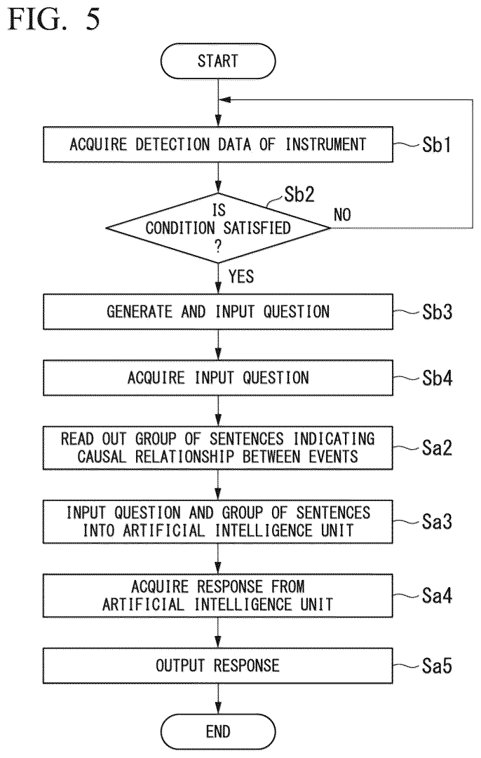

FIG. 5 is a flowchart illustrating a second example of an operation of the information processing device 10 in the present embodiment. Steps Sa2 to Sa5 in FIG. 5 are the same as steps Sa2 to Sa5 in FIG. 4, and thus the description thereof will be omitted. First, the question generation unit 15 acquires detection data of an instrument from the plant facility 20 (step Sb1). Next, the question generation unit 15 determines whether the detection data acquired in step Sb1 satisfies the set conditions (step Sb2).

In a case where it is determined in step Sb2 that the condition is not satisfied (step Sb2—No), the process returns to step Sb1. In addition, in a case where it is determined in step Sb2 that the condition is satisfied (step Sb2—Yes), the question generation unit 15 generates a question inquiring about the cause of a phenomenon and inputs it to the question input unit 11 (step Sb3). The question generated in step Sb3 may be a question corresponding to the condition satisfied in step Sb2. Next, the question input unit 11 acquires the question input in step Sb3 (step Sb4). The subsequent steps Sa2 to Sa5 are the same as those in FIG. 4.

### Second Embodiment

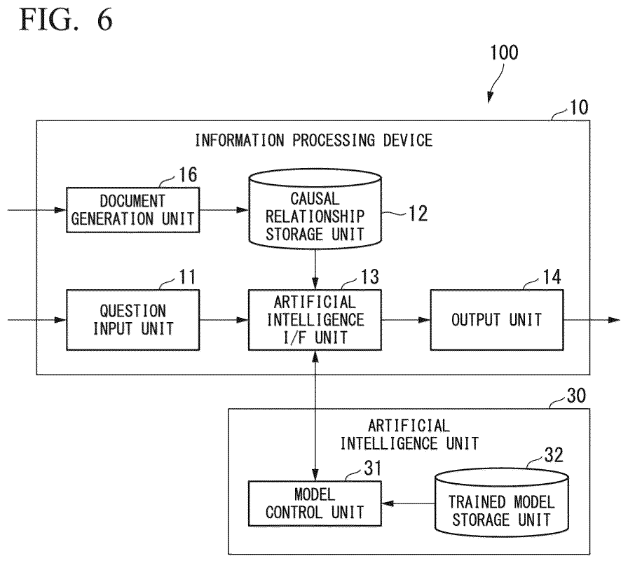

FIG. 6 is a schematic block diagram illustrating the configuration of a cause response system 100 in a second embodiment of this disclosure. The cause response system 100 in the present embodiment is substantially the same as the cause response system 100 in the first embodiment, except that it includes a document generation unit 16 and does not include the question generation unit 15.

The information processing device 10 includes the question input unit 11, the causal relationship storage unit 12, the artificial intelligence I/F unit 13, the output unit 14, and the document generation unit 16. The question input unit 11, the causal relationship storage unit 12, the artificial intelligence I/F unit 13, and the output unit 14 are the same as those in first embodiment, and thus the description thereof will be omitted. The document generation unit 16 acquires data indicating the causal relationships between events, and generates a group of sentences indicating the causal relationships between events on the basis of the data. The document generation unit 16 stores the generated group of sentences in the causal relationship storage unit 12. The group of sentences generated by the document generation unit 16 may include sentences indicating the causal relationships between causes and internally occurring events, sentences indicating the causal relationship between causes and instrument-detected events, and sentences indicating the causal relationships between internally occurring events and instrument-detected events. The document generation unit 16 may generate a group of sentences indicating the type of event on the basis of data indicating the causal relationships between events, and store it in the causal relationship storage unit 12. In addition, the document generation unit 16 may generate these groups of sentences for each facility or trouble event.

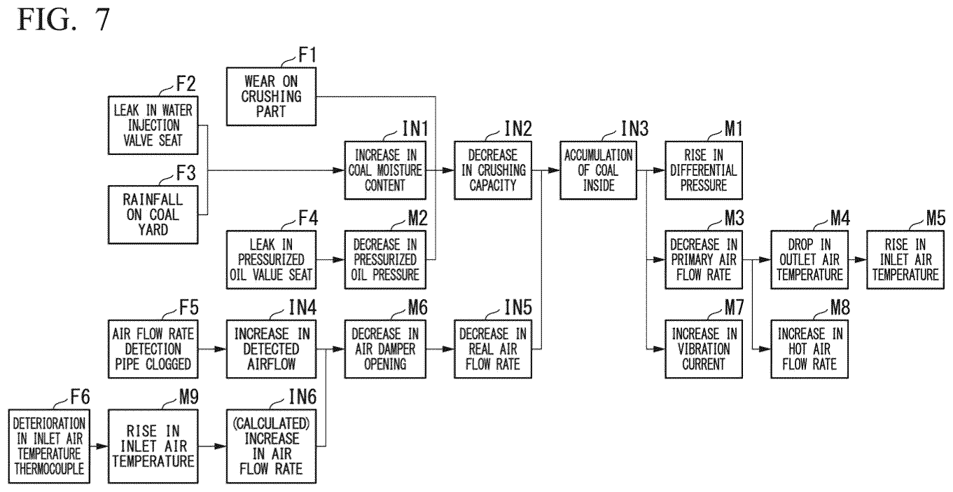

FIG. 7 is a tree diagram illustrating an example of data indicating causal relationships between events in the present embodiment. In FIG. 7, rectangles F1 to F6 are events in which the type is a cause, rectangles IN1 to IN6 are events in which the type is an internally occurring event, and rectangles M1 to M9 are events in which the type is an instrument-detected event. In addition, the arrows connecting the rectangles indicate the causal relationship between events corresponding to the rectangles. For example, the arrow from the rectangle F1 to the rectangle IN2 indicates that the event “a decrease in crushing capacity” corresponding to the rectangle IN2 occurs due to the event “wear on the crushing part” corresponding to the rectangle F1. Such tree diagram may be represented, for each rectangle, by data indicating the event corresponding to the rectangle and data indicating which rectangle the arrow from the rectangle is connected to, or by data indicating the event corresponding to the rectangle and data indicating which rectangle the arrow to the rectangle is connected from.

The document generation unit 16 has a function of editing and creating a tree diagram as shown in FIG. 7, and by editing and creating the tree diagram, it may acquire data indicating the causal relationships between events and generate a group of sentences indicating the causal relationships between events and a group of sentences indicating the type of event on the basis of the data.

In this way, the information processing device 10 in the present embodiment includes the document generation unit 16 that acquires data indicating the causal relationships between events and generates a group of sentences indicating the causal relationships between events on the basis of the data. This makes it possible for a user to easily generate a group of sentences indicating the causal relationships between events.

### Third Embodiment

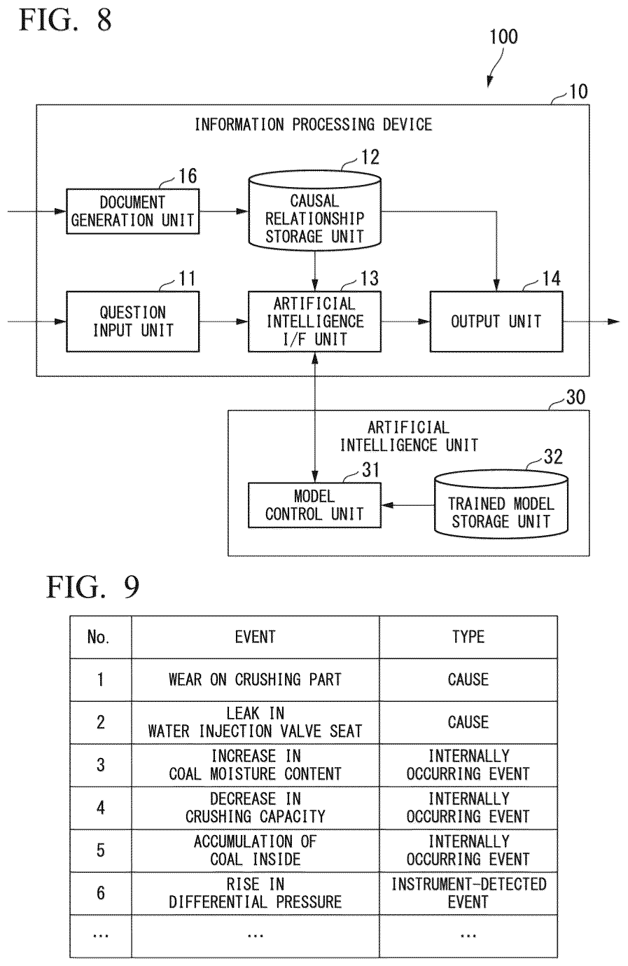

FIG. 8 is a schematic block diagram illustrating the configuration of a cause response system 100 in a third embodiment of this disclosure. The cause response system 100 in the present embodiment is substantially the same as the cause response system 100 in the second embodiment, except that the output unit 14 outputs a portion representing an event included in the response so as to be capable of identifying the type of event and that the causal relationship storage unit 12 stores information indicating the type of each event. The output unit 14 uses the information stored in the causal relationship storage unit 12 in order to identifiably output the type of event.

The information processing device 10 includes the question input unit 11, the causal relationship storage unit 12, the artificial intelligence I/F unit 13, the output unit 14, and the document generation unit 16. The question input unit 11, the causal relationship storage unit 12, the artificial intelligence I/F unit 13, and the document generation unit 16 are the same as those in the second embodiment, and thus the description thereof will be omitted. The output unit 14 outputs a portion representing an event included in the response acquired by the artificial intelligence I/F unit 13 so as to be capable of identifying the type of event. The output unit 14 may use information indicating the type of each event stored in the causal relationship storage unit 12 in order to identifiably output the type of event.

In a case where the response is “The following causes can be assumed for a rise in mill differential pressure despite the air damper being open. 1. A rise in mill differential pressure due to accumulation of coal inside: This may be result from a decrease in the mill's crushing capacity due to wear on the crushing part, an increase in coal moisture content, or a decrease in pressurized oil pressure. 2. A decrease in primary air flow rate due to accumulation of coal inside: The accumulation of coal may obstruct the flow of primary air, resulting in a decrease in primary air flow rate. . . . Other events such as ○○ may also be observed,” when the response is displayed, the output unit 14 may identifiably display the type by changing the color of the text or the background color of the text, such as “wear on the crushing part” in which the type is a cause, “an increase in coal moisture content,” “a decrease in crushing capacity,” and “the accumulation of coal inside” in which the type is an internally occurring event, and “a decrease in pressurized oil pressure,” “a decrease in primary air flow rate,” and “a decrease in primary air flow rate” in which the type is an instrument-detected event, to colors corresponding to their respective types. This makes it possible for a user to easily ascertain the type of event included in the response.

In addition, the output unit 14 may identifiably display, in an image representing the configuration of the facility, the components of the facility corresponding to the event included in the response. When the components of the facility corresponding to the event included in the response are identifiably displayed, the output unit 14 may also identifiably display the type of event. In order to identifiably display the type of event, the output unit 14 may use information indicating the type of each event stored in the causal relationship storage unit 12. Further, the causal relationship storage unit 12 may store information indicating the correspondence between the events and the components of the facility, and the output unit 14 may use this information. In addition, the output unit 14 may identifiably display the events included in the response in an image representing the causal relationships between the events.

The causal relationship storage unit 12 stores information indicating the type of each event included in the group of sentences indicating the causal relationships between events. The type of event includes at least a cause, an internally occurring event, and an instrument-detected event. Meanwhile, the information indicating the type may be generated by the document generation unit 16 on the basis of the data indicating the causal relationships between events.

FIG. 9 is a table illustrating an example of content stored in the causal relationship storage unit 12 in the present embodiment. The example shown in FIG. 9 is an example of information indicating the type of each event stored in the causal relationship storage unit 12, and the causal relationship storage unit 12 stores the event “wear on the crushing part” and the type “cause” in association with each other. The causal relationship storage unit 12 stores the event “a leak in the water injection valve seat” and the type “cause” in association with each other. The causal relationship storage unit 12 stores the event “an increase in coal moisture content” and the type “internally occurring event” in association with each other. The causal relationship storage unit 12 stores the event “a decrease in crushing capacity” and the type “internally occurring event” in association with each other. The causal relationship storage unit 12 stores the event “the accumulation of coal inside” and the type “internally occurring event” in association with each other. The causal relationship storage unit 12 stores the event “rise in differential pressure” and the type “instrument-detected event” in association with each other.

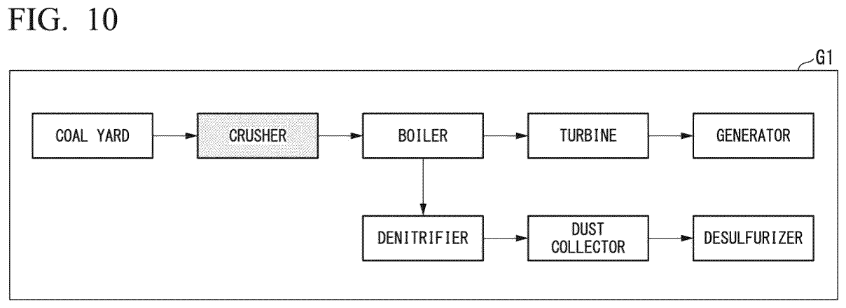

FIG. 10 is a first example of an image displayed by the output unit 14 in the present embodiment. An image G1 in FIG. 10 is a configuration diagram of the facility displayed by the output unit 14, and includes a “coal yard,” a “crusher,” a “boiler,” a “turbine,” a “generator,” a “denitrifier,” a “dust collector,” and a “desulfurizer” as components of the facility. In the image G1, only the “crusher” which is a component corresponding to the causal event included in the response is displayed in a different color from the other components. Meanwhile, this color may be a color according to the accuracy of inference of the response. In that case, the question inquiring about the cause of a phenomenon may include a phrase inquiring about the accuracy of inference of the response. The components corresponding to internally occurring events and the components corresponding to instrument-detected events included in the response may also be displayed in colors according to their types or colors according to the accuracy of inference of the response. In this way, by the output unit 14 displaying a configuration diagram of the facility such as the image G1, a user can easily ascertain the components corresponding to the events included in the response.

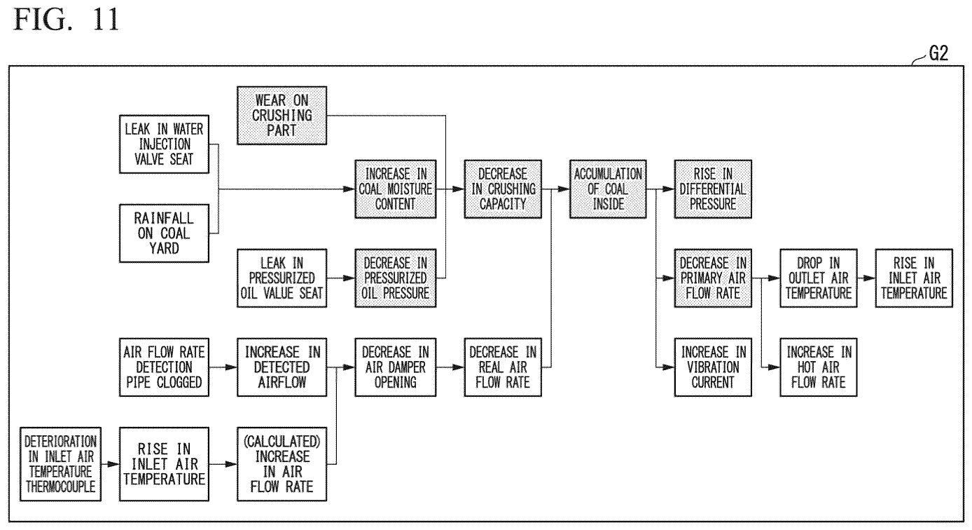

FIG. 11 is a second example of an image displayed by the output unit 14 in the present embodiment. An image G2 in FIG. 11 is a diagram representing causal relationships between events displayed by the output unit 14. In the image G2, the events included in the response, that is, “wear on the crushing part,” “an increase in coal moisture content,” “a decrease in pressurized oil pressure,” “a decrease in crushing capacity,” “the accumulation of coal inside,” “a rise in differential pressure,” and “a decrease in primary air flow rate” are displayed in a different color from the other events. Meanwhile, this color may be a color according to the accuracy of inference of the response. In that case, the question inquiring about the cause of a phenomenon may include a phrase inquiring about the accuracy of inference the response. In this way, by the output unit 14 displaying a diagram representing the causal relationships between events such as the image G2, a user can easily ascertain the events included in the response and their causal relationships.

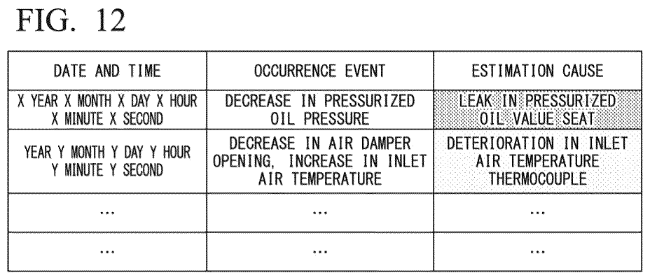

FIG. 12 is a third example of an image displayed by the output unit 14 in the present embodiment. The example of FIG. 12 is a list (alarm list) of a plurality of phenomena that have occurred in the facility displayed by the output unit 14. In this list, the time of occurrence of a phenomenon that has occurred in the facility (date and time in FIG. 12), the phenomenon (occurrence event in FIG. 12), and an event included in a response to a question inquiring about the cause of a phenomenon (estimation cause in FIG. 12) are all included in the same row. Meanwhile, the color of the column of the estimation cause may be a color according to the accuracy of inference of the response. In that case, the question inquiring about the cause of a phenomenon may include a phrase inquiring about the accuracy of inference of the response. In this way, the output unit 14 may display a plurality of phenomena that have occurred in the facility and events included in the response corresponding to each of the plurality of phenomena.

Meanwhile, the information processing device 10 in the first to third embodiments may be combined. For example, the information processing device 10 in the second and third embodiments may also be provided with the question generation unit 15, and the information processing device 10 in the first and second embodiments may also be provided with the causal relationship storage unit 12 and the output unit 14 in the third embodiment.

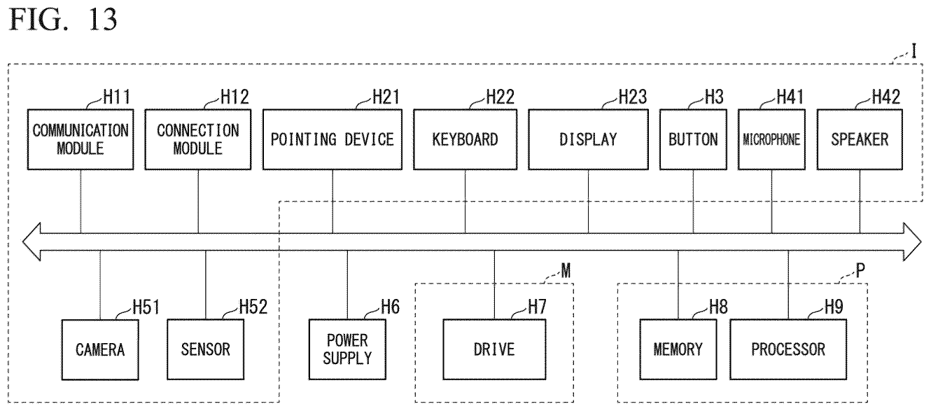

FIG. 13 is a diagram illustrating a hardware configuration of each device according to each embodiment.

Each device refers to the information processing device 10 and the artificial intelligence unit 30 in each of the first to third embodiments. Each device is configured to include an input and output module I, a storage module M, and a control module P. The input and output module I is realized by including some or all of a communication module H11, a connection module H12, a pointing device H21, a keyboard H22, a display H23, a button H3, a microphone H41, a speaker H42, a camera H51, or a sensor H52. The storage module M is realized by including a drive H7. The storage module M may further be configured to include a part or all of a memory H8. The control module P is realized by including the memory H8 and a processor H9. These hardware components are communicably connected to each other through a bus and are supplied with electric power from a power supply H6.

The connection module H12 is a digital input and output port such as a Universal Serial Bus (USB). The pointing device H21, the keyboard H22, and the display H23 may be touch panels. The sensor H52 is an acceleration sensor, a gyro sensor, a GPS reception module, a proximity sensor, or the like. The power supply H6 is a power supply unit that supplies electricity required for operating each device. The power supply H6 may be a battery. The drive H7 is an auxiliary storage medium such as a hard disk drive or a solid-state drive. The drive H7 may be a non-volatile memory such as an EEPROM or a flash memory, or may be a magneto-optic disc drive or a flexible disk drive. In addition, the drive H7 is not limited to, for example, an element built into each device, and may be an external storage device connected to a connector of the connection module H12. The memory H8 is a main storage medium such as a random access memory. Meanwhile, the memory H8 may be a cache memory. The memory H8 stores instructions when these instructions are executed by one or a plurality of processors H9. The processor H9 is a central processing unit (CPU). The processor H9 may be a micro processing unit (MPU) or a graphics processing unit (GPU). The processor H9 reads out programs and various types of data from the drive H7 through the memory H8 and performs arithmetic operations to execute instructions stored in one or a plurality of memories H8.

The input and output module I is used in the information processing device 10, the artificial intelligence unit 30, or the like. The control module P is used to implement each unit of the information processing device 10 and the artificial intelligence unit 30. Meanwhile, in the present specification or the like, the descriptions of the information processing device 10 and the artificial intelligence unit 30 may be replaced with the description of the control module P.

The present disclosure may be embodied as follows.
(1) An embodiment of the present disclosure is an information processing device including: a question input unit into which a question inquiring about a cause of a phenomenon is input; an artificial intelligence I/F unit that inputs a group of sentences indicating causal relationships between events and the question input to the question input unit into a large-scale language model, and acquires a response to the question from the large-scale language model; and an output unit that outputs the response acquired by the artificial intelligence I/F unit.
(2) In addition, another embodiment of the present disclosure is the information processing device according to (1), wherein the type of event includes a cause, an internally occurring event, and an instrument-detected event, and the response is a response regarding the cause.
(3) In addition, another embodiment of the present disclosure is the information processing device according to (2), wherein the response further includes a verifiable event.
(4) In addition, another embodiment of the present disclosure is the information processing device according to (3), wherein the verifiable event is an event different from the phenomenon of which a cause is inquired about in the question, and the type thereof is the instrument-detected event.
(5) In addition, another embodiment of the present disclosure is the information processing device according to any one of (1) to (4), wherein the phenomenon is a phenomenon detected by monitoring a facility, and the event is an event related to the facility.
(6) In addition, another embodiment of the present disclosure is the information processing device according to (5), further including a question generation unit that generates the question on the basis of a detection result of an instrument installed the facility, wherein the question generated by the question generation unit is input to the question input unit.
(7) In addition, another embodiment of the present disclosure is an information processing device including: a document generation unit that acquires data indicating causal relationships between events and generates a group of sentences indicating the causal relationships between events on the basis of the data; and an artificial intelligence I/F unit that inputs a group of input sentences including at least the group of sentences generated by the document generation unit into a large-scale language model, and acquires a response to the group of input sentences from the large-scale language model.
(8) In addition, another embodiment of the present disclosure is the information processing device according to (7), wherein the type of event includes a cause, an internally occurring event, and an instrument-detected event, and the group of sentences generated by the document generation unit includes a sentence indicating a causal relationship between the cause and the internally occurring event, a sentence indicating a causal relationship between the cause and the instrument-detected event, and a sentence indicating a causal relationship between the internally occurring event and the instrument-detected event.
(9) In addition, another embodiment of the present disclosure is the information processing device according to (7) or (8), wherein the document generation unit generates the group of sentences for each facility or trouble event.
(10) In addition, another embodiment of the present disclosure is an information processing device including: an artificial intelligence I/F unit that inputs a question inquiring about a cause of a phenomenon into a large-scale language model and acquires a response to the question from the large-scale language model; and an output unit that outputs the response acquired by the artificial intelligence I/F unit, wherein the output unit outputs a portion representing an event included in the response so as to be capable of identifying the type of event.
(11) In addition, another embodiment of the present disclosure is the information processing device according to (10), wherein the question is a question inquiring about a cause of a phenomenon related to a facility, and the output unit identifiably displays a component corresponding to the event included in the response in an image representing a configuration of the facility.
(12) In addition, another embodiment of the present disclosure is the information processing device according to (10) or (11), wherein the question is a question inquiring about a cause of a phenomenon that has occurred in a facility, and the output unit displays a plurality of phenomena that have occurred in the facility and an event included in the response corresponding to each of the plurality of phenomena.
(13) In addition, another embodiment of the present disclosure is the information processing device according to any one of (10) to (12), further including a question input unit into which the question is input, wherein the artificial intelligence I/F unit inputs a group of sentences indicating causal relationships between events and the question input to the question input unit into the large-scale language model, and acquires a response to the question from the large-scale language model.
(14) In addition, another embodiment of the present disclosure is the information processing device according to (13), further including a document generation unit that acquires data indicating causal relationships between events and generates a group of sentences indicating the causal relationships between events on the basis of the data.
(15) In addition, another embodiment of the present disclosure is the information processing device according to any one of (10) to (14), wherein the output unit identifiably displays the event included in the response in an image representing causal relationships between events.
(16) In addition, another embodiment of the present disclosure is the information processing device according to any one of (10) to (15), wherein the type of event includes at least a cause, an internally occurring event, and an instrument-detected event.
(17) In addition, another embodiment of the present disclosure is an information processing method including: a first step in which a question inquiring about a cause of a phenomenon is input; a second step of inputting a group of sentences indicating causal relationships between events and the question input in the first step into a large-scale language model, and acquiring a response to the question from the large-scale language model; and a third step of outputting the response acquired in the second step.
(18) In addition, another embodiment of the present disclosure is an information processing method including: a first step of acquiring data indicating causal relationships between events and generating a group of sentences indicating the causal relationships between events on the basis of the data; and a second step of inputting a group of input sentences including at least the group of sentences generated in the first step into a large-scale language model, and acquiring a response to the group of input sentences from the large-scale language model.
(19) In addition, another embodiment of the present disclosure is an information processing method including: a first step of inputting a question inquiring about a cause of a phenomenon into a large-scale language model and acquiring a response to the question from the large-scale language model; and a second step of outputting the response acquired in the first step, wherein the second step includes outputting a portion representing an event included in the response so as to be capable of identifying the type of event.
(20) In addition, another embodiment of the present disclosure is a program for causing a computer to function as: a question input unit into which a question inquiring about a cause of a phenomenon is input; an artificial intelligence I/F unit that inputs a group of sentences indicating causal relationships between events and the question input to the question input unit into a large-scale language model, and acquires a response to the question from the large-scale language model; and an output unit that outputs the response acquired by the artificial intelligence I/F unit.
(21) In addition, another embodiment of the present disclosure is a program for causing a computer to function as: a document generation unit that acquires data indicating causal relationships between events and generates a group of sentences indicating the causal relationships between events on the basis of the data; and an artificial intelligence I/F unit that inputs a group of input sentences including at least the group of sentences generated by the document generation unit into a large-scale language model, and acquires a response to the group of input sentences from the large-scale language model.
(22) In addition, another embodiment of the present disclosure is a program for causing a computer to function as: an artificial intelligence I/F unit that inputs a question inquiring about a cause of a phenomenon into a large-scale language model and acquires a response to the question from the large-scale language model; and an output unit that outputs the response acquired by the artificial intelligence I/F unit, wherein the output unit outputs a portion representing an event included in the response so as to be capable of identifying the type of event.

In addition, the information processing device 10 may be realized by recording a program for realizing the functions of the information processing device 10 in FIGS. 1, 6, and 8 on a computer readable recording medium, and reading and executing the program recorded on this recording medium in a computer system. Meanwhile, the term “computer system” referred to here is assumed to include an OS and hardware such as peripheral devices.

In addition, in a case where a WWW system is used, the “computer system” is also assumed to include the homepage providing environment (or display environment).

In addition, the term “computer readable recording medium” refers to a portable medium such as a flexible disk, a magneto-optic disc, a ROM, or a CD-ROM, and a storage device such as a hard disk built into a computer system. Further, the “computer readable recording medium” is assumed to include recording mediums that dynamically hold a program during a short period of time like networks such as the Internet or communication lines when a program is transmitted through communication lines such as a telephone line, and recording mediums that hold a program for a certain period of time like a volatile memory inside a computer system serving as a server or a client in that case. In addition, the above-mentioned program may be a program which is used for realizing a portion of the aforementioned functions, and may be a program which is capable of realizing the aforementioned functions by a combination of programs previously recorded in the computer system.

Although the embodiments of this disclosure have been described in detail above with reference to the drawings, the specific configurations are not limited to these embodiments, and design changes and the like are also included within the scope that does not depart from the gist of this disclosure.

### EXPLANATION OF REFERENCES

10 Information processing device
11 Question input unit
12 Causal relationship storage unit
13 Artificial intelligence I/F unit
14 Output unit
15 Question generation unit
16 Document generation unit
20 Plant facility
30 Artificial intelligence unit
31 Model control unit
32 Trained model storage unit

What is claimed is:

1. An information processing device comprising:
at least one processor; and
a memory including instructions, which when executed on the at least one processor, cause the at least one processor to function as:
a question input unit into which a question inquiring about a cause of a phenomenon is input;
an artificial intelligence I/F unit that inputs a group of sentences indicating causal relationships between events and the question input to the question input unit into a large-scale language model, and acquires a response to the question from the large-scale language model; and
an output unit that outputs the response acquired by the artificial intelligence I/F unit.

2. The information processing device according to claim 1, wherein the type of event includes a cause, an internally occurring event, and an instrument-detected event, and
the response is a response regarding the cause.

3. The information processing device according to claim 2, wherein the response further includes a verifiable event.

4. The information processing device according to claim 3, wherein the verifiable event is an event different from the phenomenon of which a cause is inquired about in the question, and the type thereof is the instrument-detected event.

5. The information processing device according to claim 1, wherein the phenomenon is a phenomenon detected by monitoring a facility, and
the event is an event related to the facility.

6. The information processing device according to claim 5, wherein the instructions further cause the at least one processor to function as: a question generation unit that generates the question on the basis of a detection result of an instrument installed the facility,
wherein the question generated by the question generation unit is input to the question input unit.

7. An information processing device comprising:
at least one processor; and
a memory including instructions, which when executed on the at least one processor, cause the at least one processor to function as:
a document generation unit that acquires data indicating causal relationships between events and generates a group of sentences indicating the causal relationships between events on the basis of the data; and
an artificial intelligence I/F unit that inputs a group of input sentences including at least the group of sentences generated by the document generation unit into a large-scale language model, and acquires a response to the group of input sentences from the large-scale language model.

8. The information processing device according to claim 7, wherein the type of event includes a cause, an internally occurring event, and an instrument-detected event, and
the group of sentences generated by the document generation unit includes a sentence indicating a causal relationship between the cause and the internally occurring event, a sentence indicating a causal relationship between the cause and the instrument-detected event, and a sentence indicating a causal relationship between the internally occurring event and the instrument-detected event.

9. The information processing device according to claim 7, wherein the document generation unit generates the group of sentences for each facility or trouble event.

10. An information processing device comprising:
at least one processor; and
a memory including instructions, which when executed on the at least one processor, cause the at least one processor to function as:
an artificial intelligence I/F unit that inputs a question inquiring about a cause of a phenomenon into a large-scale language model and acquires a response to the question from the large-scale language model; and
an output unit that outputs the response acquired by the artificial intelligence I/F unit,
wherein the output unit outputs a portion representing an event included in the response so as to be capable of identifying the type of event.

11. The information processing device according to claim 10, wherein the question is a question inquiring about a cause of a phenomenon related to a facility, and
the output unit identifiably displays a component corresponding to the event included in the response in an image representing a configuration of the facility.

12. The information processing device according to claim 10, wherein the question is a question inquiring about a cause of a phenomenon that has occurred in a facility, and
the output unit displays a plurality of phenomena that have occurred in the facility and an event included in the response corresponding to each of the plurality of phenomena.

13. The information processing device according to claim 10, wherein the instructions further cause the at least one processor to function as: a question input unit into which the question is input,
wherein the artificial intelligence I/F unit inputs a group of sentences indicating causal relationships between events and the question input to the question input unit into the large-scale language model, and acquires a response to the question from the large-scale language model.

14. The information processing device according to claim 13, wherein the instructions further cause the at least one processor to function as: a document generation unit that acquires data indicating causal relationships between events and generates a group of sentences indicating the causal relationships between events on the basis of the data.

15. The information processing device according to claim 10, wherein the output unit identifiably displays the event included in the response in an image representing causal relationships between events.

16. The information processing device according to claim 10, wherein the type of event includes at least a cause, an internally occurring event, and an instrument-detected event.

17. An information processing method comprising:
inputting a question inquiring about a cause of a phenomenon;
inputting a group of sentences indicating causal relationships between events and the question into a large-scale language model;
acquiring a response to the question from the large-scale language model; and
outputting the response acquired.

18. An information processing method comprising:
acquiring data indicating causal relationships between events;
generating a group of sentences indicating the causal relationships between events on the basis of the data;
inputting a group of input sentences including at least the group of sentences generated into a large-scale language model; and
acquiring a response to the group of input sentences from the large-scale language model.

19. An information processing method comprising:
inputting a question inquiring about a cause of a phenomenon into a large-scale language model;
acquiring a response to the question from the large-scale language model; and
outputting the response acquired,
wherein the outputting includes outputting a portion representing an event included in the response so as to be capable of identifying the type of event.

20. A non-transitory computer-readable medium having stored thereon a program for causing a computer to function as:
a question input unit into which a question inquiring about a cause of a phenomenon is input;
an artificial intelligence I/F unit that inputs a group of sentences indicating causal relationships between events and the question input to the question input unit into a large-scale language model, and acquires a response to the question from the large-scale language model; and
an output unit that outputs the response acquired by the artificial intelligence I/F unit.

21. A non-transitory computer-readable medium having stored thereon a program for causing a computer to function as:
a document generation unit that acquires data indicating causal relationships between events and generates a group of sentences indicating the causal relationships between events on the basis of the data; and
an artificial intelligence I/F unit that inputs a group of input sentences including at least the group of sentences generated by the document generation unit into a large-scale language model, and acquires a response to the group of input sentences from the large-scale language model.

22. A non-transitory computer-readable medium having stored thereon a program for causing a computer to function as:
an artificial intelligence I/F unit that inputs a question inquiring about a cause of a phenomenon into a large-scale language model and acquires a response to the question from the large-scale language model; and
an output unit that outputs the response acquired by the artificial intelligence I/F unit,
wherein the output unit outputs a portion representing an event included in the response so as to be capable of identifying the type of event.
